(19) United States
(12) Patent Application Publication
(10) Pub. No.: US 2017/0215670 A1
(43) Pub. Date: Aug. 3, 2017

(54) DUST SENSOR, DUST MEASURING APPARATUS, ROBOT CLEANER, AND METHOD OF CONTROLLING THE SAME

(71) Applicant: EVERYBOT INC., Seongnam-si, Gyeonggi-do (KR)

(72) Inventors: Joo Pyo HEO, Namyangju-si, Gyeonggi-do (KR); Seong Gyun KIM, Seoul (KR); Ki Yong LEE, Jeju-si, Jeju-do (KR); Ji Hun JUNG, Seoul (KR)

(73) Assignee: EVERYBOT INC., Seongnam-si, Gyeonggi-do (KR)

(21) Appl. No.: 15/514,638

(22) PCT Filed: Sep. 4, 2015
(86) PCT No.: PCT/KR2015/009339

§ 371 Date: Mar. 27, 2017

(30) Foreign Application Priority Data
Sep. 26, 2014 (KR) 10-2014-0129107

(51) Int. Cl. A47L 9/28; G01N 21/55; G01N 21/94; A47L 11/40

(52) U.S. Cl. CPC A47L 9/2815; A47L 9/2894; A47L 11/4011; G01N 21/55; G01N 21/94; A47L 2201/06; G01N 2021/0112

(57) ABSTRACT

Provided herein is a dust measuring apparatus. The dust measuring apparatus includes: a body; a window unit exposed to the outside through an opening part of the body, such that dust present in the outside is gathered on the window unit; a light emitting unit emitting light to the window unit; a light receiving unit receiving light reflected from the window unit; and a controlling unit measuring an amount of dust gathered on the window unit on the basis of strength of the emitted light and strength of the received light.

### TECHNICAL FIELD

The present invention relates to a dust sensor sensing dust, a dust measuring apparatus measuring an amount of dust using the dust sensor, a robot cleaner performing cleaning while automatically traveling, and a method of controlling the same.

### BACKGROUND ART

Recently, an interest in health has increased to such an extent that there is a trend toward well-being meaning that people healthily live.

Particularly, it is considered that air cleanliness of a living room or a room in which people spend much time in the home is significantly associated with the health.

Therefore, a dust measuring apparatus measuring a pollution level of the interior is separately provided in the general home to induce air of the interior to be cleaned depending on measurement of the dust measuring apparatus.

However, in a scheme of measuring dust according to the related art, an amount of dust floating in the air in a closed environment in which external light is not incident is measured.

Therefore, the scheme of measuring dust according to the related art is appropriate for a solution such as an air cleaner, but is not appropriate for a robot cleaner cleaning a floor.

### DISCLOSURE

### Technical Problem

An object of the present invention is to provide a dust sensor capable of sensing dust in an environment exposed to the outside, a dust measuring apparatus, a robot cleaner, and a method of controlling the same.

### Technical Solution

According to an exemplary embodiment of the present invention, a dust measuring apparatus may include: a body; a window unit exposed to the outside through an opening part of the body, such that dust present in the outside is gathered on the window unit; a light emitting unit emitting light to the window unit; a light receiving unit receiving light reflected from the window unit; and a controlling unit measuring an amount of dust gathered on the window unit on the basis of strength of the emitted light and strength of the received light.

According to another exemplary embodiment of the present invention, a robot cleaner may include: a driving unit providing driving force for driving the robot cleaner; a traveling unit traveling the robot cleaner depending on the driving force; a communicating unit receiving identification information of a plurality of dust measuring apparatuses positioned in a plurality of cleaning spaces and information on measured amounts of dust from each of the plurality of dust measuring apparatuses; and a controlling unit determining cleaning spaces on which cleaning is to be performed on the basis of the received information and controlling the driving unit to travel the robot cleaner to the determined cleaning spaces.

According to still another exemplary embodiment of the present invention, a robot cleaner may include: a body forming an appearance of the robot cleaner; a window unit exposed to the outside through an opening part of the body, such that dust present in the outside is gathered on the window unit; a light emitting unit emitting light to the window unit; a light receiving unit receiving light reflected from the window unit; and a controlling unit measuring an amount of dust gathered on the window unit on the basis of strength of the emitted light and strength of the received light.

According to yet still another exemplary embodiment of the present invention, a dust sensor may include: a window unit exposed to the outside, such that dust present in the outside is gathered on the window unit; a light emitting unit emitting light to the window unit; and a light receiving unit receiving light reflected from the window unit, wherein the window unit has a predetermined curvature so that incident emitted light is refracted toward the outside when the emitted light is incident to a region of the window unit in which the dust is not present.

According to yet still another exemplary embodiment of the present invention, a method of controlling a robot cleaner including a window unit exposed to the outside through an opening part of the body, such that dust present in the outside is gathered on the window unit may include: emitting light to the window unit; receiving light reflected from the window unit; measuring an amount of dust gathered on the window unit on the basis of strength of the emitted light and strength of the received light; and powering on the robot cleaner to perform a cleaning travel, when the measured amount of dust is larger than a preset amount of dust.

### ADVANTAGEOUS EFFECTS

According to the various exemplary embodiments of the present invention described above, a dust sensor capable of sensing dust in an environment exposed to the outside and accurately calculating an amount of dust gathered on a window unit, and a dust measuring apparatus including the same and a robot cleaner including the same may be provided.

In addition, according to the various exemplary embodiments of the present invention described above, a robot cleaner automatically waken up to perform a cleaning travel when an amount of dust becomes larger than a preset amount even though a cleaning command of a user is not input may be provided.

Further, according to the various exemplary embodiments of the present invention described above, a robot cleaner performing communication with a dust measuring apparatus and determining a cleaning space in which a large amount of dust is present depending on the communication to perform cleaning on the cleaning space may be provided.

### DESCRIPTION OF DRAWINGS

FIG. 1 is a perspective view illustrating a dust sensor according to an exemplary embodiment of the present invention.

FIG. 2 is a vertical cross-sectional view illustrating the dust sensor according to an exemplary embodiment of the present invention.

FIGS. 3 and 4 are views illustrating light emission and light reception operations of the dust sensor according to an exemplary embodiment of the present invention.

FIG. 5 is a perspective view illustrating a dust measuring apparatus including the dust sensor according to an exemplary embodiment of the present invention.

FIG. 6 is a plan view illustrating the dust measuring apparatus including the dust sensor according to an exemplary embodiment of the present invention.

FIG. 7 is a front view illustrating the dust measuring apparatus including the dust sensor according to an exemplary embodiment of the present invention.

FIG. 8 is a block diagram illustrating the dust measuring apparatus according to an exemplary embodiment of the present invention.

FIG. 9 is a view illustrating an output screen of the dust measuring apparatus according to an exemplary embodiment of the present invention.

FIG. 10 is a perspective view illustrating a robot cleaner according to an exemplary embodiment of the present invention.

FIG. 11 is a bottom view illustrating the robot cleaner according to an exemplary embodiment of the present invention.

FIG. 12 is a block diagram illustrating the robot cleaner according to an exemplary embodiment of the present invention.

FIG. 13 is a flow chart illustrating cleaning traveling processes of the robot cleaner according to an exemplary embodiment of the present invention.

FIG. 14 is a timing chart illustrating cleaning traveling processes of a robot cleaner according to another exemplary embodiment of the present invention.

FIG. 15 is a perspective view illustrating a dust measuring apparatus according to another exemplary embodiment of the present invention.

FIG. 16 is a timing chart illustrating cleaning traveling processes of a robot cleaner according to another exemplary embodiment of the present invention.

### BEST MODE

The following description illustrates only a principle of the present invention. Therefore, those skilled in the art may implement the principle of the present invention and invent various apparatuses included in the spirit and scope of the present invention although not clearly described or illustrated in the present specification. In addition, it is to be understood that all conditional terms and exemplary embodiments mentioned in the present specification are obviously intended only to allow those skilled in the art to understand a concept of the present invention in principle, and the present invention is not limited to exemplary embodiments and states particularly mentioned as such.

Further, it is to be understood that all detailed descriptions mentioning specific exemplary embodiments of the present invention as well as principles, aspects, and exemplary embodiments of the present invention are intended to include structural and functional equivalences thereof. Further, it is to be understood that these equivalences include an equivalence that will be developed in the future as well as an equivalence that is currently well-known, that is, all elements invented so as to perform the same function regardless of a structure.

Therefore, it is to be understood that, for example, block diagrams of the present specification illustrate a conceptual aspect of an illustrative circuit for embodying a principle of the present invention. Similarly, it is to be understood that all flow charts, state transition diagrams, pseudo-codes, and the like, illustrate various processes that may be tangibly embodied in a computer-readable medium and that are executed by computers or processors regardless of whether or not the computers or the processors are clearly illustrated.

Functions of various elements including processors or functional blocks represented as concepts similar to the processors and illustrated in the accompanying drawings may be provided using hardware having capability to execute appropriate software as well as dedicated hardware. When the functions are provided by the processors, they may be provided by a single dedicated processor, a single shared processor, or a plurality of individual processors, and some of them may be shared with each other.

In addition, terms mentioned as a processor, a control, or a concept similar to the processor or the control should not be interpreted to exclusively cite hardware having capability to execute software, but should be interpreted to implicitly include digital signal processor (DSP) hardware and a read only memory (ROM), a random access memory (RAM), and a non-volatile memory for storing software without being limited thereto. The above-mentioned terms may also include well-known other hardware.

In the claims of the present specification, components represented as means for performing functions mentioned in a detailed description are intended to include all methods of performing functions including all types of software including, for example, a combination of circuit elements performing these functions, firmware/micro codes, or the like, and are coupled to appropriate circuits for executing the software so as to execute these functions. It is to be understood that since functions provided by variously mentioned means are combined with each other and are combined with a method demanded by the claims in the present invention defined by the claims, any means capable of providing these functions are equivalent to means recognized from the present specification.

The above-mentioned objects, features, and advantages will become more obvious from the following detailed description associated with the accompanying drawings. Therefore, those skilled in the art to which the present invention pertains may easily practice a technical idea of the present invention. Further, in describing the present invention, in the case in which it is decided that a detailed description of a well-known technology associated with the present invention may unnecessarily make the gist of the present invention unclear, it will be omitted.

Hereinafter, various exemplary embodiments of the present invention will be described in detail with reference to the accompanying drawings.

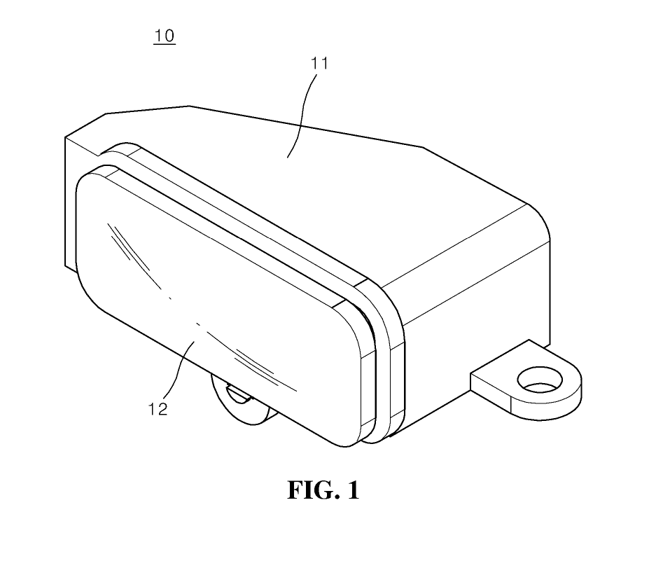

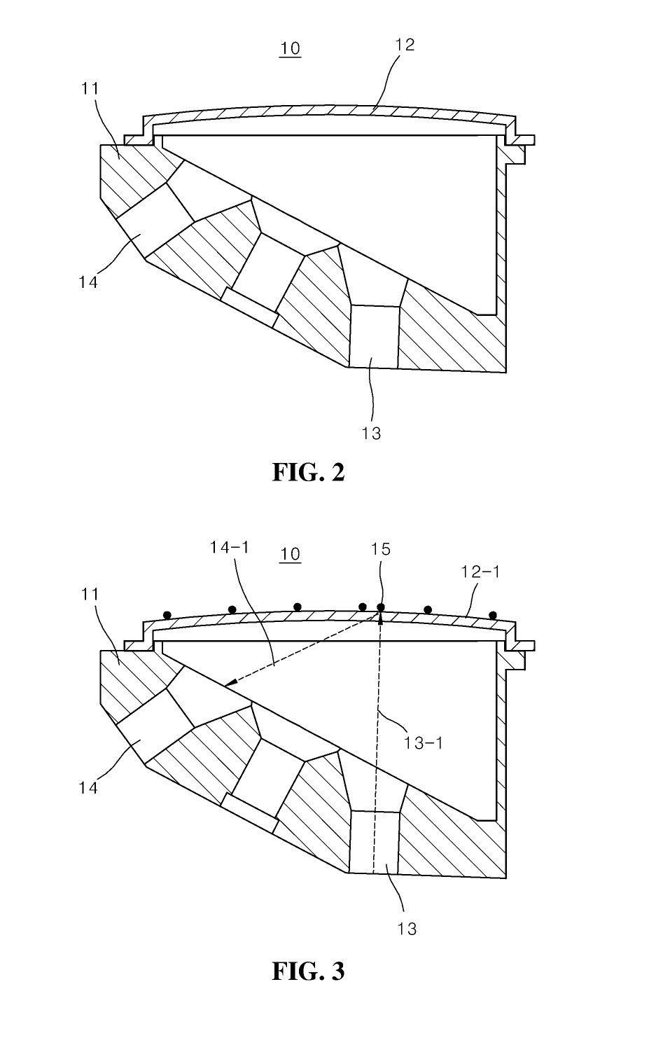

FIG. 1 is a perspective view illustrating a dust sensor according to an exemplary embodiment of the present invention. FIG. 2 is a vertical cross-sectional view illustrating the dust sensor according to an exemplary embodiment of the present invention. Referring to FIGS. 1 and 2, the dust sensor 10 includes a body 11 of the dust sensor, a window unit 12, a light emitting unit 13 emitting light to the window unit 12, and a light receiving unit 14 receiving light reflected from the window unit 12.

The window unit 12 is exposed to an external space, such that it may be exposed to external light such as illumination light, solar light, or the like, while dust present in the air being gathered on an air exposed surface of the window unit 12.

The light emitting unit 13 is formed at one side facing the window unit 12, and may emit the light toward the window unit 12.

The light receiving unit 14 is formed at the other side facing the window unit 12, and may receive the reflected light when the light emitted from the light emitting unit 13 toward the window unit 12 is reflected.

Here, the light emitting unit 13 and the light receiving unit 14 may be preferably implemented, respectively, by an infrared light emitting unit and an infrared light receiving unit using infrared light. However, this is only an exemplary embodiment of the present invention, and according to another exemplary embodiment, the light emitting unit 13 and the light receiving unit 14 may be implemented by elements using another light such as laser beam, or the like.

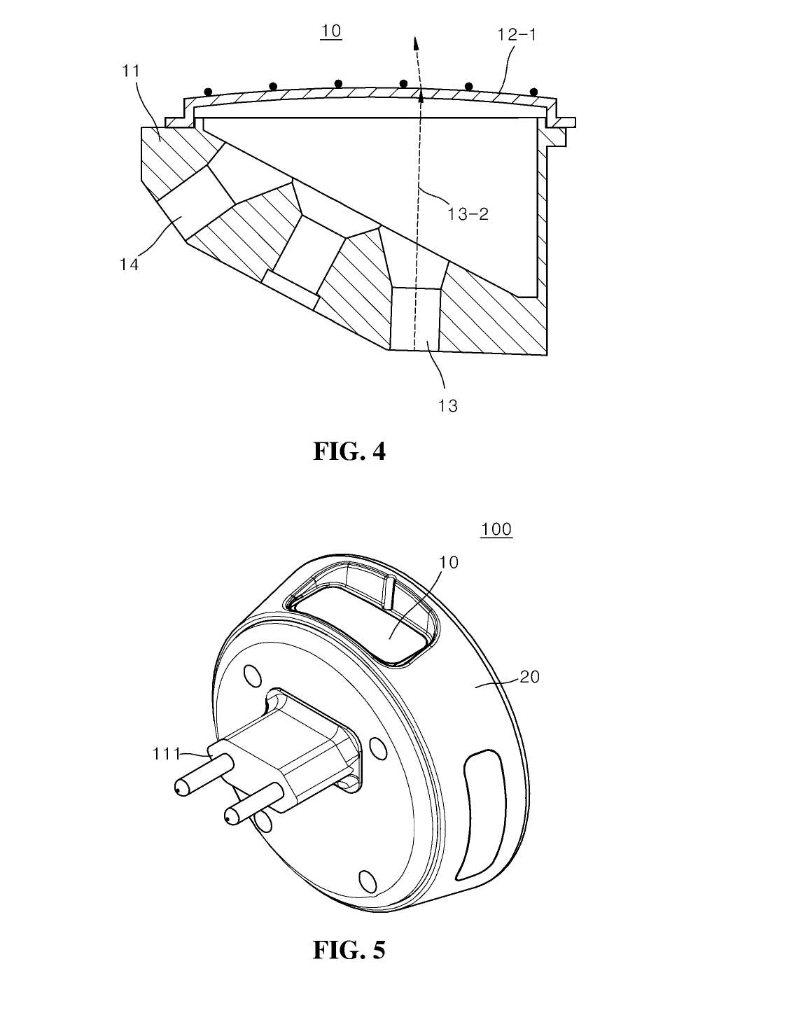

Meanwhile, the window unit 12 may have a predetermined curvature, and may have a shape in which at least one surface thereof is convex toward an external space depending on the predetermined curvature. As an example, as illustrated in FIGS. 1 and 2, a surface of the window unit 12 exposed to the external space may have a shape convex toward the external space. Depending on the predetermined curvature, the dust sensor 10 according to an exemplary embodiment of the present invention may output an accurate sensing value to accurately calculate an amount of dust gathered on the window unit 12. This will be described in detail with reference to FIGS. 3 and 4.

Referring to FIG. 3, dust 15 may be gathered on an external exposed surface 12-1 of the window unit 12, the light emitting unit 13 may emit the light toward the window unit 12, and emitted light 13-1 may be transmitted through the window unit 12 and be then reflected by the dust 15 on the external exposed surface 12-1.

In this case, reflected light 14-1 generated by the reflection of the emitted light 13-1 by the dust may be received in the light receiving unit 14.

Referring to FIG. 4, dust 15 may be gathered on an external exposed surface 12-1 of the window unit 12, the light emitting unit 13 may emit the light toward the window unit 12, and emitted light 13-2 may be transmitted through the window unit 12 and be then incident to a region of the external exposed surface 12-1 on which the dust 15 is not present.

In this case, the emitted light 13-2 is not reflected to an inner portion of the dust sensor 10, but may be refracted depending on the predetermined curvature and be then emitted to an external space.

That is, referring to FIGS. 3 and 4, the dust sensor 10 according to an exemplary embodiment of the present invention may decrease an amount of light reflected by the surface of the window unit 12 rather than the dust gathered on the window unit 12, thereby making it possible to suppress other influences besides the dust from being reflected on a sensing value of the dust sensor 10. Therefore, an amount of dust gathered on the window unit 12 may be accurately calculated on the basis of the sensing value of the dust sensor 10.

The dust sensor 10 described above may be implemented by a module including each of the window unit 12, the light emitting unit 13, and the light receiving unit 14 installed in an accommodating space of the body 11, as illustrated in FIGS. 1 to 4. The modularized dust sensor 10 may be installed in various apparatuses, such as a dust measuring apparatus 100, a robot cleaner 200, an air cleaning apparatus, and the like, and be used as a sensor for measuring an amount of dust in the air.

Meanwhile, although a case in which the dust sensor 10 includes one light emitting unit 13 and one light receiving unit 14 has been described by way of example in FIGS. 1 to 4, the dust sensor 10 may include a plurality of light emitting units 13 and a plurality of light receiving units 14 according to another example.

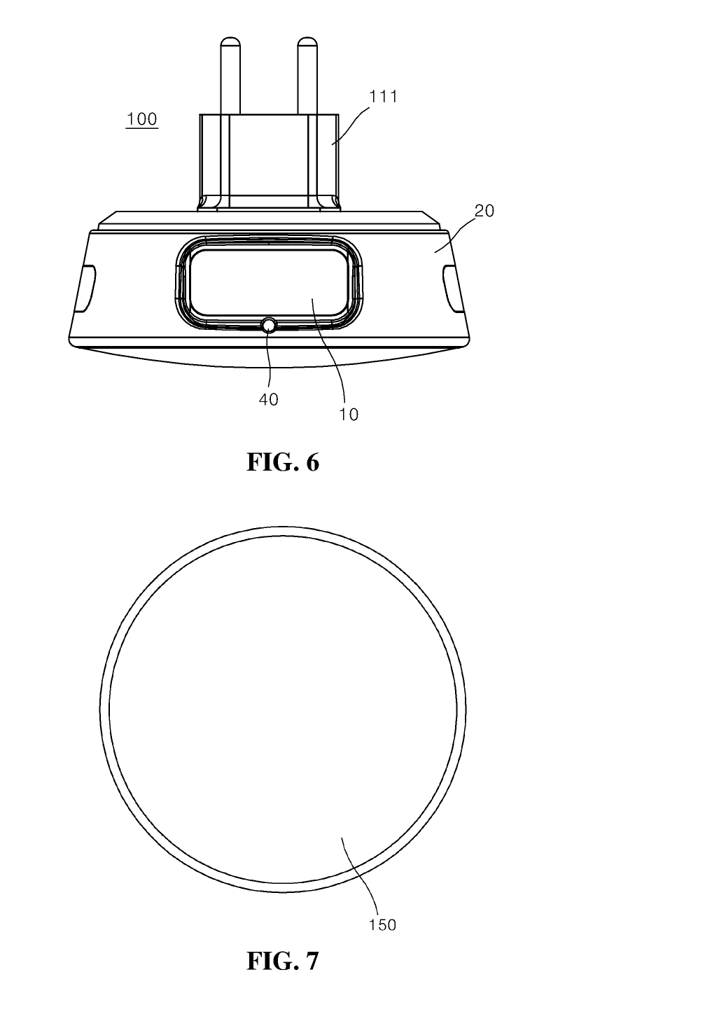

FIG. 5 is a perspective view illustrating a dust measuring apparatus including the dust sensor according to an exemplary embodiment of the present invention. FIG. 6 is a plan view illustrating the dust measuring apparatus including the dust sensor according to an exemplary embodiment of the present invention. FIG. 7 is a plan view illustrating the dust measuring apparatus including the dust sensor according to an exemplary embodiment of the present invention. Referring to FIGS. 5 to 7, the dust measuring apparatus 100 includes a body 20 forming an appearance of the dust measuring apparatus 100, a dust sensor 10 including a window unit 12 exposed through an opening part of the body 20, an illuminance sensor 40, a plug 111 receiving power for an operation of the dust measuring apparatus 100, and a display unit 150 displaying related information of the dust measuring apparatus 100.

Here, the dust sensor 10 may be implemented by the dust sensor described above with reference to FIGS. 1 to 4, and may include the window unit 12 exposed to the outside through the opening part of the body 20 of the dust measuring apparatus, such that it is exposed to external light such as illumination light, solar light, or the like, while dust present in the outside being gathered on the window unit 12, the light emitting unit 13 emitting the light to the window unit 12, and the light receiving unit 14 receiving the light reflected from the window unit.

The dust sensor 10 described above may be positioned at an upper portion of the body 20 on the basis of the fixed dust measuring apparatus 100 so that the dust present in the air may be gathered well on the window unit 12. That is, when the dust sensor 10 is fixed, the window unit 12 of the dust sensor 10 may be directed upwardly.

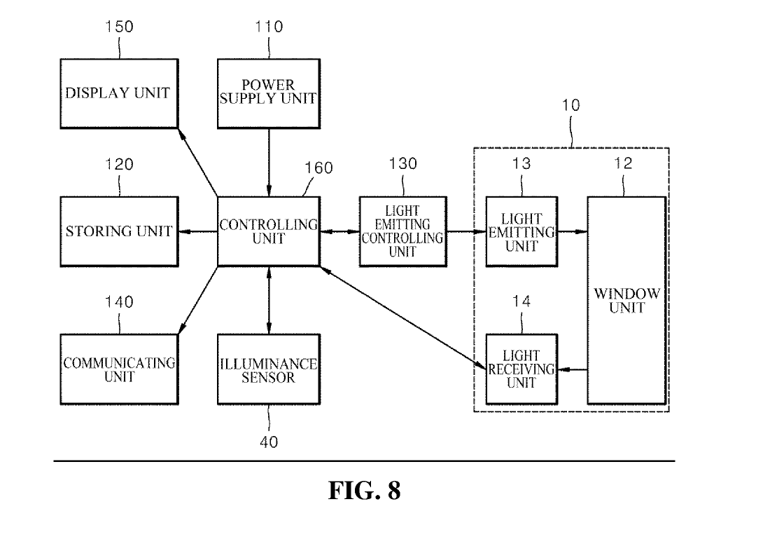

Meanwhile, the dust measuring apparatus 100 may measure an amount of dust gathered on the window unit 12 using a sensing value of the dust sensor 10, and utilize the measured amount of dust. This will be described in detail with reference to FIG. 8.

FIG. 8 is a block diagram illustrating the dust measuring apparatus according to an exemplary embodiment of the present invention. Referring to FIG. 8, the dust measuring apparatus 100 may include all or some of a power supply unit 110, a storing unit 120, a light emitting controlling unit 130, a communicating unit 140, a display unit 150, a controlling unit 160, the dust sensor 10, and the illuminance sensor 40. Here, the dust sensor 10 may be a sensor including the window unit 12, the light emitting unit 13, and the light receiving unit 14 described above with reference to FIGS. 1 to 4.

The power supply unit 110 supplies power to the dust measuring apparatus 100. In detail, the power supply unit 110 may supply the power for driving and operating the respective functional units constituting the dust measuring apparatus 100 to the respective functional units. Here, the power supply unit 110 may include a plug 111, or the like, to be implemented in a form in which it receives and uses alternating current (AC) power from an external power supplying apparatus. However, the power supply unit 110 is not limited thereto, but may be implemented by a rechargeable battery.

The storing unit 120 stores various programs and data for an operation of the dust measuring apparatus 100 therein. In detail, the storing unit 120 may store information capable of identifying each of a plurality of dust measuring apparatuses 100, such as serial numbers, or the like, of the dust measuring apparatuses 100, therein.

In addition, the storing unit 120 may store information for measurement of an amount of dust to which an amount of dust gathered on the window unit 12 is matched depending on a ratio of strength of received light of the light receiving unit 14 to strength of emitted light of the light emitting unit 13 therein. As an example, the storing unit 120 may store the information as illustrated in the following Table 1 therein.

TABLE 1

| Strength of Emitted | Strength of Received | Amount (%) of Dust |
|---|---|---|
| Light | Light | Gathered on Window Unit |
| A | B | 80% |
| | C | 50% |

In this case, the storing unit 120 may store the information in a form of a lookup table (LUT) therein.

Here, the storing unit 120 may be implemented by a detachable type of storing element such as a universal serial bus (USB) memory, or the like, as well as an embedded type of storing element such as a random access memory (RAM), a flash memory, a read only memory (ROM), an erasable programmable ROM (EPROM), an electronically erasable and programmable ROM (EEPROM), a register, a hard disk, a removable disk, a memory card, or the like.

The communicating unit 140 may enable communication between the dust measuring apparatus 100 and an external apparatus. Particularly, the communicating unit 140 may enable communication between the dust measuring apparatus 100 and the robot cleaner 200 performing cleaning while autonomously traveling. Therefore, the communicating unit 140 may transmit information on the measured amount of dust to the robot cleaner 200.

Here, the communicating unit 140 may include wired/wireless communication modules performing communication in a wireless or wired scheme through a local area network (LAN) and the Internet network, a universal serial bus (USB) interface module performing communication through a USB port, a mobile communication module performing communication by accessing a mobile communication network depending on various mobile communication standards such as 3^{rd} Generation (3G), 3^{rd} generation partnership project (3GPP), long term evolution (LTE), and the like, and a short range communication module performing communication through a short range wireless communication scheme such as the near field communication (NFC), Wi-Fi, Zigbee, or nRF.

In addition, the communicating unit 140 according to an exemplary embodiment of the present invention may include a short range wireless communication chip (a short range wireless communication module) performing nRF or Bluetooth low energy (BLE) communication. Bluetooth low energy is a wireless communication protocol used to transmit a message at a low energy, and a BLE specification is defined in Volume 6 of the Bluetooth specification.

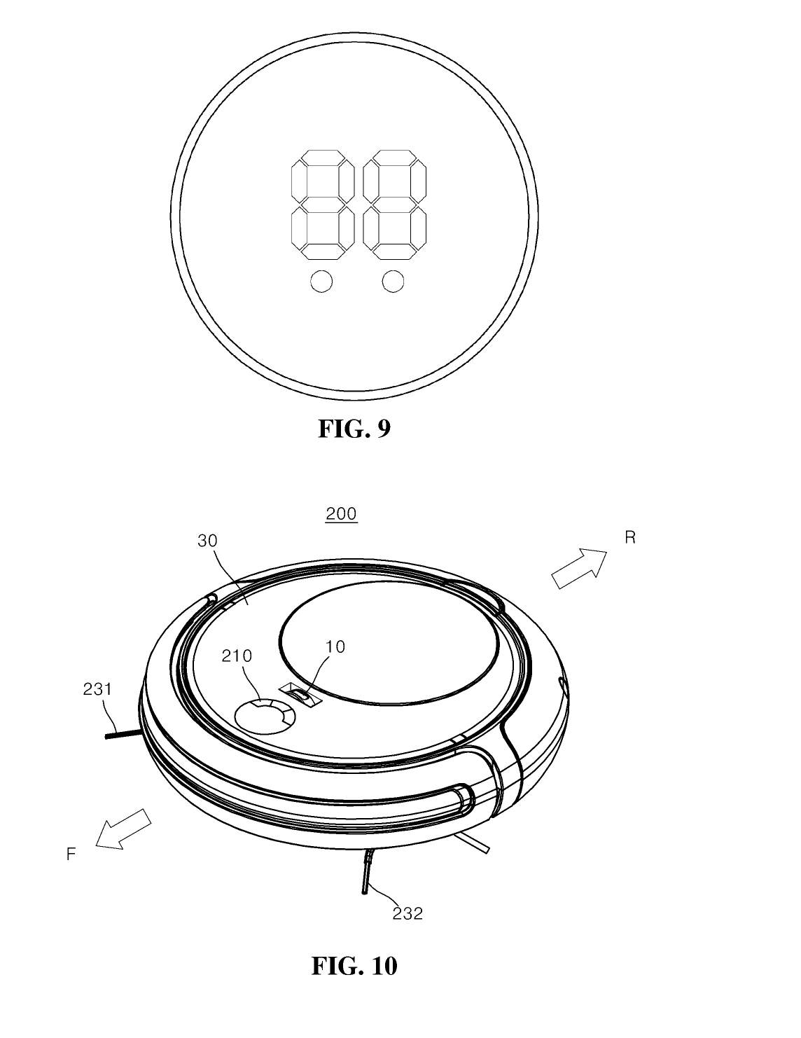

The display unit 150 may output information related to the amount of dust as data that may be visually recognized. As an example, as illustrated in FIG. 9, the display unit 150 may digitize and output the amount of dust.

Here, the display unit 150 may be implemented by at least one of a liquid crystal display, a thin film transistor-liquid crystal display, an organic light-emitting diode, a flexible display, a three-dimensional (3D) display, a transparent display, a head up display (HUD), a head mounted display (HMD), and a prism project display.

The illuminance sensor 40 may be exposed to the outside through the opening part of the body 20 of the dust measuring apparatus to sense an external illuminance. Here, the illuminance sensor 40 may include a light receiving element formed of a device such as a photodiode converting strength of the received light into a corresponding current.

The controlling unit 160 controls a general operation of the dust measuring apparatus 100. In detail, the controlling unit 160 may control all or some of the power supply unit 110, the storing unit 120, the communicating unit 140, the display unit 150, the dust sensor 10, and the illuminance sensor 40.

Particularly, the controlling unit 160 may measure the amount of dust gathered on the window unit 12 of the dust sensor 10 with reference to the above Table 1 stored in the storing unit 120 on the basis of the strength of the emitted light of the light emitting unit 13 and the strength of the received light of the light receiving unit 14. Here, each of the strength of the emitted light and the strength of the received light may be calculated by measuring a current flowing in each of the light emitting unit 13 and the light receiving unit 14 by the controlling unit 160.

The controlling unit 160 may control power supplied from a power supply to the light emitting unit 13 to allow the strength of the emitted light of the light emitting unit 13 to be constant.

Meanwhile, a table such as the above Table 1 represents values measured by an experiment in a dark environment in which an influence of external light such as illumination light, solar light, or the like, is low, for the purpose of accurate measurement of an amount of dust corresponding to a ratio. Therefore, in the case in which the window unit 12 of the dust sensor 10 is exposed to the external space to be exposed to the external light as in an exemplary embodiment of the present invention, an error may be generated in the calculated amount of dust. Therefore, the controlling unit 160 according to an exemplary embodiment of the present invention may compensate for the strength of the received light of the light receiving unit 14 using a sensing value of the illuminance sensor 40, and measure the amount of dust gathered on the window unit 12 on the basis of the compensated strength of the received light and the strength of the emitted light. Therefore, the controlling unit 160 may reflect an influence of the external light to measure an accurate amount of dust.

The controlling unit 160 may control the communicating unit 140 to transmit a packet including information on the measured amount of dust and identification information of the dust measuring apparatus to the robot cleaner 200 using the nRF communication.

Meanwhile, the controlling unit 160 may control the communicating unit 140 to transmit a packet including information on the measured amount of dust and identification information of the dust measuring apparatus to the robot cleaner 200 using the BLE communication.

As an example, the dust measuring apparatus 100 may serve as an advertiser defined in the BLE. In this case, the communicating unit 140 may broadcast the packet including the information on the measured amount of dust and the identification information of the dust measuring apparatus. In detail, the communicating unit 140 may always perform the broadcasting in the case in which the dust measuring apparatus 100 is turned on. Alternatively, the communicating unit 140 may perform the broadcasting in the case in which the measured amount of dust is larger than a preset amount of dust.

Here, the broadcasting has a coverage, which may correspond to a radius of approximately 50 to 100m. Here, the coverage may be changed depending on various factors.

In this case, a robot cleaner 200 that may perform the BLE communication and is positioned in the coverage may receive the packet broadcasted from the dust measuring apparatus 100. However, a robot cleaner 200 that is not positioned in the coverage among robot cleaners 200 that may perform the BLE communication may not receive the broadcast packet.

Meanwhile, the robot cleaner 200 may determine a cleaning space on which cleaning is to be performed on the basis of the information received depending on the broadcasting, and may travel to the determined cleaning space to perform the cleaning.

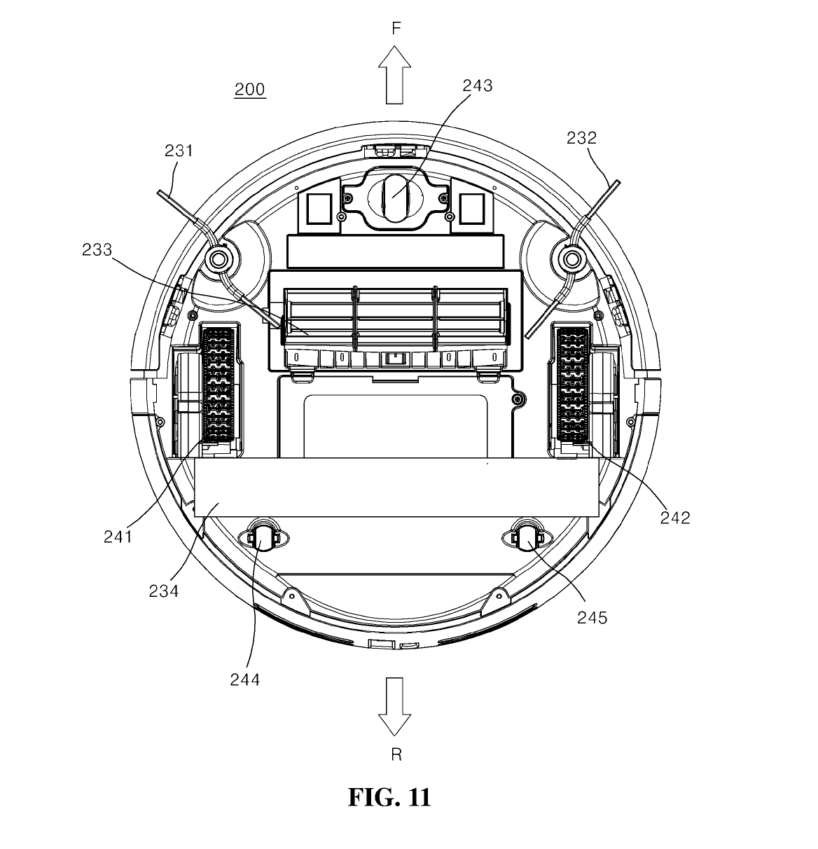

FIG. 10 is a perspective view illustrating a robot cleaner according to an exemplary embodiment of the present invention. FIG. 11 is a bottom view illustrating the robot cleaner according to an exemplary embodiment of the present invention. Referring to FIGS. 10 and 11, the robot cleaner 200 according to an exemplary embodiment of the present invention may structurally include a body 30 forming an appearance of the robot cleaner, an input and output unit 210 including an input unit receiving a user input manipulating the robot cleaner 200 and an output unit outputting robot cleaner related information, main wheels 241 and 242 enabling moving motions such as forward movement, rearward movement, rotation traveling, and the like, in a process in which the robot cleaner 200 performs a cleaning travel, and auxiliary wheels 243, 244, and 245 rotated depending on a traveling direction of the robot cleaner 200 to allow the body to maintain a stable posture.

Here, two main wheels 241 and 242 may be disposed at left and right edges of a central region of a bottom surface of the body 30 so as to be symmetrical to each other, as an example. In addition, the auxiliary wheels 243, 244, and 245 may be disposed at front and rear ends of the bottom surface of the body as an example, and may be implemented by casters.

In addition, the robot cleaner 200 according to an exemplary embodiment of the present invention may include a dust sensor 10 including a window unit 12 exposed to the outside through an opening part of the body 30, such that it may be exposed to external light such as illumination light, solar light, or the like, while dust present in the outside being gathered, a light emitting unit 13 emitting light to the window unit 12, and a light receiving unit 14 receiving the light reflected from the window unit. Here, the dust sensor 10 may be implemented by the dust sensor described above with reference to FIGS. 1 to 4. The dust sensor 10 described above may be positioned at an upper portion of the robot cleaner 200 so that the dust present in the air may be gathered well on the window unit 12.

In addition, the robot cleaner 200 according to an exemplary embodiment of the present invention may include a main brush assembly 233 and side brush assemblies 231 and 232 performing dry cleaning for absorbing and removing free particles such as dust, or the like, present on a surface to be cleaned, and may include a cleaner fixing unit 234 to which a cleaner performing wet cleaning for removing foreign materials stuck to the surface to be cleaned using a solution such as water, detergent, or the like, may be fixed.

Here, the cleaner fixing unit 234 may be disposed at a lower end of the bottom surface of the body 30, and the cleaner implemented by a fiber material such as superfine fiber cloth, dustcloth, non-woven fabric, brush, and the like, capable of wiping the foreign materials stuck to the surface to be cleaned may be fixed to the cleaner fixing unit 234.

In addition, the side brush assemblies 231 and 232 may brush the free particles such as the dust, or the like, present on corner portions of a floor surface, that is, portions adjacent to walls, to induce the free particles to the main brush assembly 233. Here, two side brush assemblies 231 and 232 may be disposed at edges of left and right upper ends of the bottom surface of the body 30 so as to be symmetrical to each other, as an example, a first side brush assembly 231 positioned at the left in the bottom view may rotate in a clockwise direction, and a second side brush assembly 232 positioned at the right in the bottom view may rotate in a counterclockwise direction.

The main brush assembly 233 may brush the free particles induced from the side brush assemblies 231 and 232 to induce the free particles to an inlet. Here, one main brush assembly 233 may be disposed in a central region of the bottom surface of the body 30 as an example.

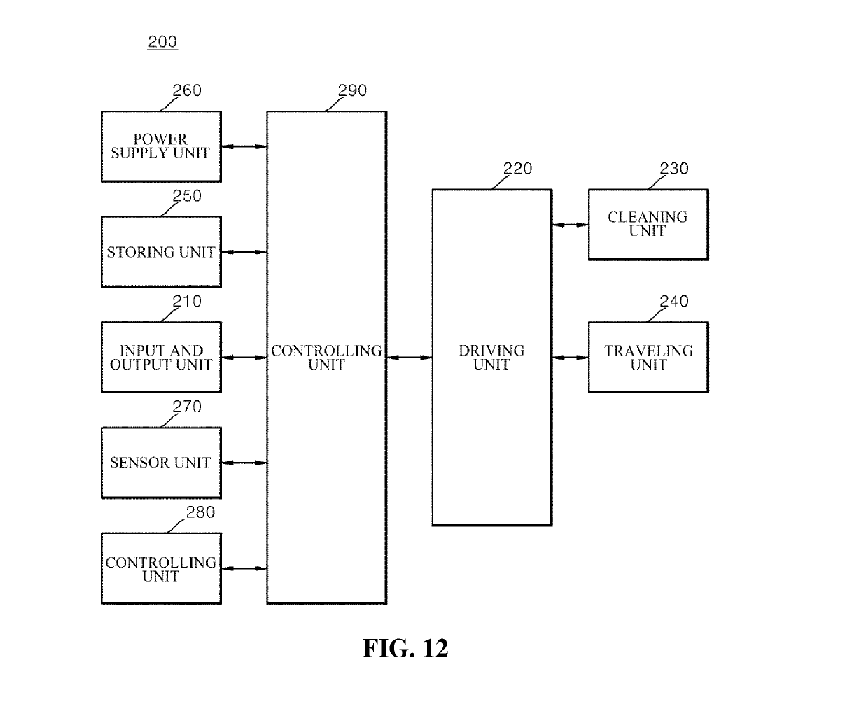

FIG. 12 is a block diagram illustrating the robot cleaner according to an exemplary embodiment of the present invention. Referring to FIG. 12, the robot cleaner 200 includes all or some of the body 30 forming the appearance of the robot cleaner, the input and output unit 210, a driving unit 220, a cleaning unit 230, a traveling unit 240, a storing unit 250, a power supply unit 260, a sensor unit 270, a communicating unit 280, a controlling unit 290, and a light emitting controlling unit (not illustrated).

The input and output unit 210 includes the input unit receiving the user input manipulating the robot cleaner and the output unit outputting the robot cleaner related information. In detail, the input unit may receive various user inputs such as a user input manipulating power-on/off of the robot cleaner, a user input manipulating a cleaning mode of the robot cleaner, a user input manipulating an operation or a stop of the robot cleaner, and the like. Here, the input unit may be formed of a keypad, a dome switch, a touch pad (a resistive or capacitive touch pad), a jog wheel, a jog switch, or the like.

In addition, the output unit may output the robot cleaner related information such as a battery state of the robot cleaner, the cleaning mode of the robot cleaner, and the like, and may include an audio output unit outputting data that may be auditorily recognized and a display unit outputting data that may be visually recognized. Here, the audio output unit may be implemented by a speaker. In addition, the display unit may be implemented to include at least one of a liquid crystal display (LCD), a thin film transistor-liquid crystal display (TFT LCD), an organic light-emitting diode (OLED), a flexible display, a field emission display (FED), a 3D Display, and a transparent display.

The driving unit 220 may provide driving force for driving each of the cleaning unit 230 and the traveling unit 240. In detail, the driving unit 220 may include motors rotating the main wheels of the traveling unit 240, and drive the motors to travel the robot cleaner. The motors are connected to the main wheels to allow the main wheels to rotate, and are independently operated such that bi-direction rotation is possible. In addition, the driving unit 220 includes motors rotating each of the main brush assembly 233 and the side brush assemblies 231 and 232, and may drive the motors to allow the robot cleaner 200 to perform dry cleaning.

The traveling unit 240 travels the robot cleaner 200 depending on the driving of the driving unit 220. Here, the traveling unit 240 may include the main wheels 241 and 242 enabling moving motions such as forward movement, rearward movement, rotation traveling, and the like, in a process in which the robot cleaner 200 performs the cleaning depending on the driving of the driving unit 220.

In addition, the traveling unit 240 may include the auxiliary wheels 243, 244, and 245. Here, the auxiliary wheels 243, 244, and 245 may support the body of the robot cleaner 200, minimize friction between the robot cleaner and the floor surface (the surface to be cleaned), and allow the robot cleaner 200 to smoothly travel. Here, the auxiliary wheels 243, 244, and 245 may be implemented by the casters rotated depending on a traveling direction of the robot cleaner 200 to allow the body to maintain a stable posture.

The cleaning unit 230 cleans a cleaning zone. Here, the cleaning unit 230 includes the main brush assembly 233 brushing the free particles such as the dust, or the like, present on the surface to be cleaned such as the floor surface, or the like, to induce the free particles to the inlet and the side brush assemblies 231 and 232 cleaning the portions adjacent to the walls and corner portions.

The main brush assembly 233 may include a roller that is rotatable and a main brush that is installed to surround an outer peripheral surface of the roller and is rotated. Here, the main brush may stir the dust gathered on the floor surface depending on rotation of the roller to induce the dust to be introduced into the inlet. Here, the roller may be formed of a rigid body.

Meanwhile, although not illustrated in the drawings, the cleaning unit 230 may include a suction unit (not illustrated) generating suction force in the inlet to allow the free particles induced to the inlet to be sucked into the inlet and a dust collecting apparatus (not illustrated) collecting the dust introduced to the inlet by the suction unit. Here, the suction unit may be implemented by a suction motor as an example.

In addition, the cleaning unit 230 according to an exemplary embodiment of the present invention may include the cleaner fixing unit 234 capable of fixing the cleaner for wet cleaning. Here, the cleaner fixing unit 234 may be positioned at a lower portion of the body. Here, the cleaner may be implemented by the fiber material such as the superfine fiber cloth, the dustcloth, the non-woven fabric, the brush, and the like, capable of wiping the foreign materials stuck to the floor surface.

In addition, the cleaning unit 230 according to an exemplary embodiment of the present invention may further include a water supplying unit (not illustrated) for improving dustcloth cleaning capability of the cleaner.

The storing unit 250 stores various programs and data for an operation of the robot cleaner 200 therein. In detail, the storing unit 250 may store one or more of cleaning map information and cleaning region information of the robot cleaner therein.

In addition, the storing unit 250 may store information for measurement of an amount of dust to which an amount of dust gathered on the window unit 12 is matched depending on a ratio of strength of received light of the light receiving unit 14 to strength of emitted light of the light emitting unit 13 therein. As an example, the storing unit 250 may store the information as illustrated in the above Table 1 therein.

Here, the storing unit 250 may be implemented by a detachable type of storing element such as a universal serial bus (USB) memory, or the like, as well as an embedded type of storing element such as a random access memory (RAM), a flash memory, a read only memory (ROM), an erasable programmable ROM (EPROM), an electronically erasable and programmable ROM (EEPROM), a register, a hard disk, a removable disk, a memory card, a universal subscriber identity module (USIM), or the like.

The power supply unit 260 supplies power to the robot cleaner 200. In detail, the power supply unit 260 may supply driving power and operation power required for the robot cleaner to travel or perform the cleaning to the respective functional units constituting the robot cleaner 200, and may allow the robot cleaner to move to a charging station when a remaining amount of power is insufficient, such that it receives a charging current to be charged with the charging current. Here, the power supply unit 160 may be implemented by a rechargeable battery.

The sensor unit 270 may sense various kinds of information on a cleaning travel of the robot cleaner 200. In detail, the sensor unit 270 may include one or more sensors provided on a side surface of the body 30 described above and sensing a second obstacle that the robot cleaner may not climb, such as a wall. In addition, the sensor unit 270 may include one or more sensors positioned on a lower end of a front surface and/or a rear surface of the body 30 and sensing a first obstacle having a predetermined height, such as a doorsill, or the like. Here, the sensors sensing the first and second obstacles may be implemented by an obstacle detecting sensor, a camera sensor, or the like, transmitting infrared or ultrasonic signals to the outside and receiving signals reflected from the obstacles, as an example.

In addition, the sensor unit 270 may include a sensor sensing a traveling state such as a traveling distance, a traveling speed, a traveling acceleration, or the like, of the robot cleaner 200, for example, an acceleration sensor.

In addition, the sensor unit 270 may include the dust sensor 10 and the illuminance sensor 20 described above. The sensor unit 270 described above may transfer a sensing signal to the controlling unit 290.

The communicating unit 280 may include one or more modules enabling wireless communication between the robot cleaner 200 and another wireless terminal or between the robot cleaner 200 and a network in which another wireless terminal is positioned. For example, the communicating unit 280 may communicate with a wireless terminal, which is a remote controller. To this end, the communicating unit 280 may include a short range communication module, a wireless Internet module, or the like.

An operation state, an operation method, or the like, of the robot cleaner 200 may be controlled by a control signal received by the communicating unit 280 as described above. An example of a terminal controlling the robot cleaner 200 may include a smart phone, a tablet personal computer, a personal computer, a remote controller, and the like, that may communicate with the robot cleaner 200.

The controlling unit 290 controls a general operation of the robot cleaner 200. In detail, the controlling unit 290 may control all or some of the input and output unit 210, the driving unit 220, the cleaning unit 230, the traveling unit 240, the storing unit 250, the power supply unit 260, the sensor unit 270, and the communicating unit 280.

Particularly, the controlling unit 290 may measure the amount of dust gathered on the window unit 12 of the dust sensor 10 with reference to the above Table 1 stored in the storing unit 250 on the basis of the strength of the emitted light of the light emitting unit 13 and the strength of the received light of the light receiving unit 14.

In addition, in order to more accurately measure the amount of dust, the controlling unit 290 may compensate for the strength of the received light of the light receiving unit 14 using a sensing value of the illuminance sensor 40, and measure the amount of dust gathered on the window unit 12 on the basis of the compensated strength of the received light and the strength of the emitted light.

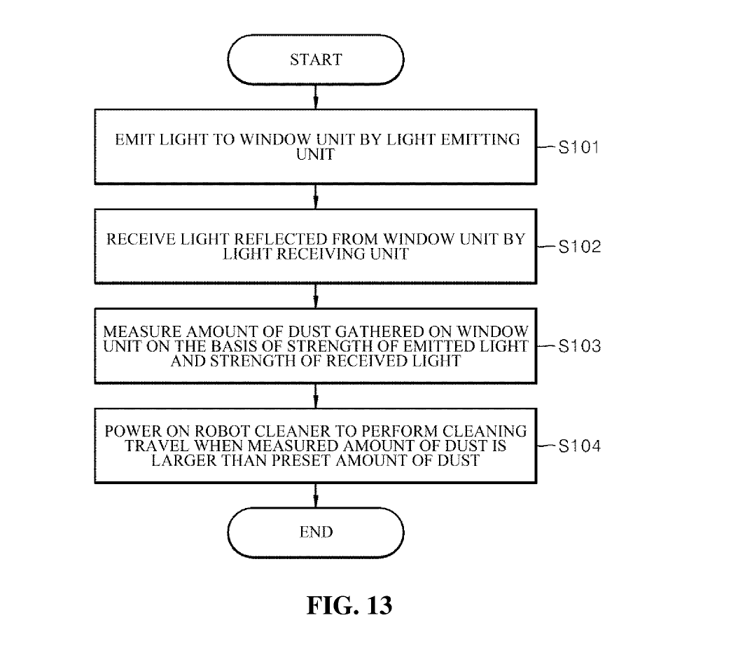

In addition, when the measured amount of dust is larger than a preset amount of dust, the controlling unit 290 may control the driving unit 220 to allow the robot cleaner 200 to perform a cleaning travel. In detail, the power may be supplied to components for measuring the amount of dust, for example, the dust sensor 10, the illuminance sensor 20, the controlling unit 290, and the like, even in a power-off state of the robot cleaner 200. When an amount of dust measured in the power-off state is larger than a preset amount of dust, the controlling unit 290 automatically powers on the robot cleaner 200, and the power supply unit 260 may supply the power to components for the cleaning travel, for example, the input and output unit 210, the driving unit 220, the cleaning unit 230, the traveling unit 240, the storing unit 250, the power supply unit 260, the sensor unit 270, and the communicating unit 280. Therefore, even though a cleaning command of a user is not input, the robot cleaner 200 may be automatically waken up to perform the cleaning travel. These processes are illustrated in FIG. 13.

In detail, the robot cleaner 200 including the dust sensor may perform operations as illustrated in FIG. 13. First, the light emitting unit 13 of the dust sensor 10 may emit the light to the window unit 12 of the dust sensor 10 (S101), and the light receiving unit 140 of the dust sensor 10 may receive the light reflected from the window unit 12 (S102).

In addition, the controlling unit 290 may measure the amount of dust gathered on the window unit 12 on the basis of the strength of the emitted light and the strength of the received light (S103).

Here, S101, S102, and S103 may be performed since the supply of the power to components for performing each of S101, S102, and S103 is not blocked even in the power-off state of the robot cleaner 200.

Meanwhile, when the measured amount of dust is larger than a preset amount of dust, the controlling unit 290 powers on the robot cleaner to perform the cleaning travel (S104).

Meanwhile, a robot cleaner 200 according to another exemplary embodiment of the present invention may not include the dust sensor 10, which is a component for measuring the amount of dust.

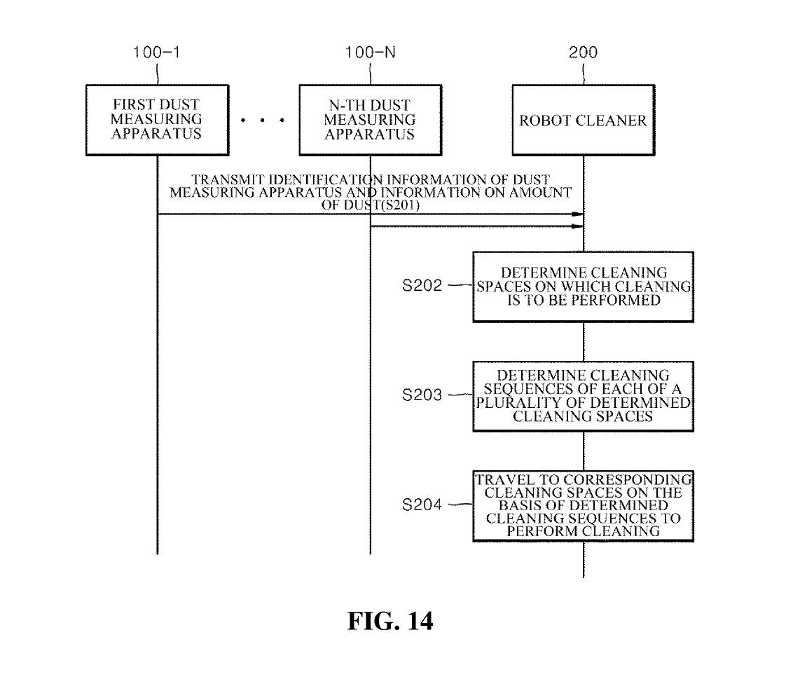

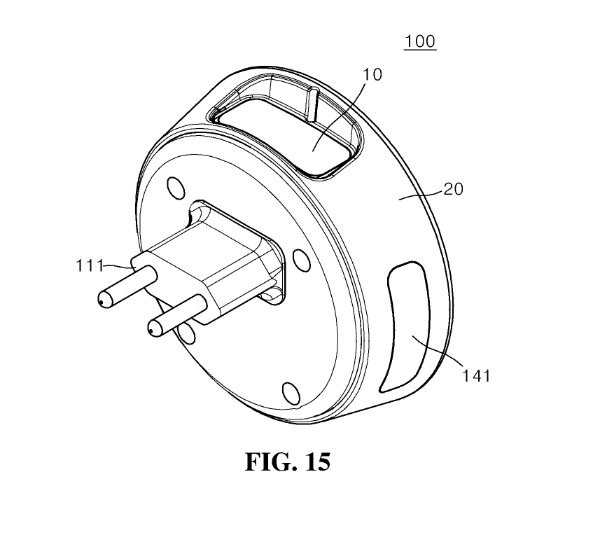

In this case, the robot cleaner 200 may perform the cleaning in association with the dust measuring apparatus 100. This will be described in detail with reference to FIG. 14.

Referring to FIG. 14, the robot cleaner 200 may first receive identification information of a plurality of dust measuring apparatuses 100-1 to 100-N positioned in a plurality of cleaning spaces and information on measured amounts of dust from each of the plurality of dust measuring apparatuses (S201). As an example, the dust measuring apparatuses 100 may serve as advertisers defined in BLE. In this case, the dust measuring apparatuses 100 may broadcast packets including information on the measured amounts of dust and the identification information of the dust measuring apparatuses. Therefore, the robot cleaner 200 may receive signals broadcasted from each of the plurality of dust measuring apparatuses 100-1 to 100-N positioned in the plurality of cleaning spaces to receive the identification information of the dust measuring apparatuses and the information on the measured amounts of dust.

In addition, the robot cleaner 200 may determine cleaning spaces on which the cleaning is to be performed on the basis of the received information (S202). In detail, the robot cleaner 200 may determine the cleaning spaces on which the cleaning is to be performed by detecting the identification information of the dust measuring apparatuses 100 in which the measured amounts of dust are larger than a preset amount using the received information. Here, the plurality of cleaning spaces may be distinguished from each other by the identification information of dust measuring apparatuses 100 positioned in each of the plurality of cleaning spaces.

In addition, when a plurality of cleaning spaces on which the cleaning is to be performed are determined, the robot cleaner 200 may determine cleaning sequences of each of the plurality of determined cleaning spaces (S203). In this case, the robot cleaner 200 may determine the cleaning sequences in descending order from a cleaning space in which an amount of dust is large. For example, in the case in which an amount of dust measured by a first dust measuring apparatus 100-1 positioned in a cleaning space A is 80% and an amount of dust measured by a second dust measuring apparatus 100-2 positioned in a cleaning space B is 70%, the robot cleaner 200 may determine that a cleaning sequence of the cleaning space A is No. 1 and determine that a cleaning sequence of the cleaning space B is No. 2.

In addition, the robot cleaner 200 may travel to corresponding cleaning spaces on the basis of the determined cleaning sequences to perform the cleaning (S204). In this case, the robot cleaner 200 may travel to the corresponding cleaning spaces using pre-stored cleaning map data.

However, according to another exemplary embodiment, the robot cleaner 200 may travel to the corresponding cleaning space using received signal strength indicators (RSSIs) of the signals broadcast from the plurality of dust measuring apparatuses 100. In this case, the robot cleaner 200 may determine a current position of the robot cleaner using a triangulation method, or the like, on the basis of the RSSIs of the signals broadcast from the plurality of dust measuring apparatuses 100. In addition, the robot cleaner may travel to the corresponding cleaning spaces while updating the determined current position on the basis of RSSIs of the continuously received broadcast signals, thereby performing the cleaning.

FIG. 15 is a perspective view illustrating a dust measuring apparatus according to another exemplary embodiment of the present invention. Referring to FIG. 15, the dust measuring apparatus 100 may further include an infrared (IR) communicating unit 141 for IR communication as well as the body 20, the dust sensor 10 including the window unit 12 exposed through the opening part of the body 20, the illuminance sensor 40, the plug 111 receiving the power for the operation of the dust measuring apparatus 100, and the display unit 150 displaying the related information of the dust measuring apparatus 100, which are components of the dust measuring apparatus 100 described above with reference to FIGS. 5 to 9.

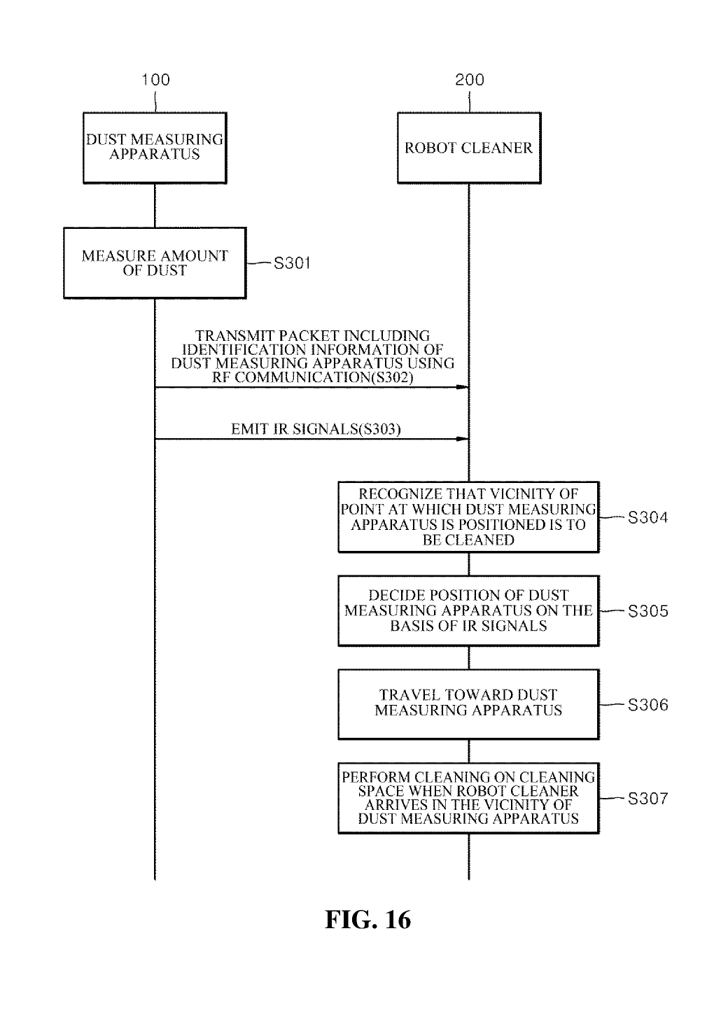

Here, the IR communicating unit 141 may include a first IR communicating unit installed on a first side surface of the dust measuring apparatus 100 and emitting an IR signal in a first direction, and a second IR communicating unit installed on a second side surface of the dust measuring apparatus 100 opposing to the first side surface and emitting an IR signal in a second direction. The IR signals described above may be received in an IR communicating unit of the robot cleaner 200 and be used for the robot cleaner 200 to recognize a position of the dust measuring apparatus 100. This will be described in detail with reference to FIG. 16.

Referring to FIG. 16, the dust measuring apparatus 100 may first measure the amount of dust gathered on the window unit 12 of the dust sensor 10 on the basis of the strength of the emitted light of the light emitting unit 13 and the strength of the received light of the light receiving unit 14 (S301).

In addition, when the measured amount of dust is larger than a preset amount of dust, the dust measuring apparatus 100 may transmit the packet including the identification information of the dust measuring apparatus to the robot cleaner 200 using RF communication (S302).

In addition, the dust measuring apparatus 100 may emit the IR signals (S303) before, after, or simultaneously with S302.

Meanwhile, the robot cleaner 200 receiving the packet may recognize that the vicinity of a point at which the dust measuring apparatus corresponding to the received identification information is positioned is to be cleaned (S304). Here, the packet may be used as a wake-up signal of the robot cleaner 200. That is, in the case in which the robot cleaner 200 is in a power-off state, the robot cleaner 200 receiving the packet may recognize that it is powered on and is then to perform cleaning on the point at which the dust measuring apparatus 100 is positioned, and in the case in which the robot cleaner 200 is in a power-on state, the robot cleaner 200 may recognize that it is to perform cleaning on the point at which the dust measuring apparatus 100 is positioned.

In this case, the robot cleaner 200 may decide a position of the dust measuring apparatus 100 on the basis of the IR signals emitted from the dust measuring apparatus 100 (S305), and travel toward the corresponding dust measuring apparatus 100 (S306).

In addition, when the robot cleaner arrives in the vicinity of the dust measuring apparatus 100 depending on the travel, the robot cleaner 200 may perform cleaning on a cleaning space in which the corresponding dust measuring apparatus 100 is positioned (S307).

Meanwhile, the method of controlling a robot cleaner according to various exemplary embodiments of the present invention described above may be implemented by program codes and be provided in the respective servers or apparatuses in a state in which it is stored in various non-transitory computer-readable media.

The non-transitory computer readable medium is not a medium that stores data therein for a while, such as a register, a cache, a memory, or the like, but means a medium that semi-permanently stores data therein and is readable by a device. In detail, various applications or programs described above may be stored and provided in the non-transitory computer readable medium such as a compact disk (CD), a digital versatile disk (DVD), a hard disk, a Blu-ray disk, a universal serial bus (USB), a memory card, a read only memory (ROM), or the like.

Although the exemplary embodiments of the present invention have been illustrated and described hereinabove, the present invention is not limited to the above-mentioned specific exemplary embodiments, but may be variously modified by those skilled in the art to which the present invention pertains without departing from the scope and spirit of the present invention as disclosed in the accompanying claims. These modifications should also be understood to fall within the scope of the present invention.

1. A dust measuring apparatus comprising:
a body;
a window unit exposed to the outside through an opening part of the body, such that dust present in the outside is gathered on the window unit;
a light emitting unit emitting light to the window unit;
a light receiving unit receiving light reflected from the window unit; and
a controlling unit measuring an amount of dust gathered on the window unit on the basis of strength of the emitted light and strength of the received light.

2. The dust measuring apparatus of claim 1, wherein the window unit has a predetermined curvature so that incident emitted light is refracted toward the outside when the emitted light is incident to a region of the window unit in which the dust is not present.

3. The dust measuring apparatus of claim 2, wherein the window unit reflects incident emitted light toward the light receiving unit when the emitted light is incident to a region of the window unit in which the dust is present.

4. The dust measuring apparatus of claim 3, wherein the window unit has a shape in which at least one surface thereof is convex toward the outside depending on the predetermined curvature.

5. The dust measuring apparatus of claim 1, further comprising:
a power supply unit supplying power for an operation of the dust measuring apparatus; and
a light emitting controlling unit controlling power supplied to the light emitting unit so that the strength of the emitted light is constant.

6. The dust measuring apparatus of claim 1, wherein the window unit is exposed to the outside through the opening part of the body to be thus exposed to external light.

7. The dust measuring apparatus of claim 6, further comprising:
a storing unit storing information for measurement of the amount of dust therein; and
an illuminance sensor sensing an illuminance of the external light, wherein the controlling unit compensates for the strength of the received light using a sensing result of the illuminance sensor and calculates the amount of dust gathered on the window unit on the basis of the compensated strength of the received light and the strength of the emitted light.

8. The dust measuring apparatus of claim 6, further comprising a communicating unit communicating with a robot cleaner performing cleaning while autonomously traveling, wherein the communicating unit transmits a packet including identification information of the dust measuring apparatus and information of the measured amount of dust.

9. (canceled)

10. (canceled) -cm 11. (canceled)

12. A robot cleaner comprising:
a body forming an appearance of the robot cleaner;
a window unit exposed to the outside through an opening part of the body, such that dust present in the outside is gathered on the window unit;
a light emitting unit emitting light to the window unit;
a light receiving unit receiving light reflected from the window unit; and
a controlling unit measuring an amount of dust gathered on the window unit on the basis of strength of the emitted light and strength of the received light.

13. The robot cleaner of claim 12, further comprising:
a driving unit providing driving force for driving the robot cleaner;
a traveling unit traveling the robot cleaner depending on the driving force; and
a cleaning unit performing cleaning depending on the driving force, wherein the controlling unit controls the driving unit to allow the robot cleaner to perform a cleaning travel, when the measured amount of dust is larger than a preset amount of dust.

14. The robot cleaner of claim 12, wherein the window unit has a predetermined curvature so that incident emitted light is refracted toward the outside when the emitted light is incident to a region of the window unit in which the dust is not present.

15. The robot cleaner of claim 14, wherein the window unit reflects incident emitted light toward the light receiving unit when the emitted light is incident to a region of the window unit in which the dust is present.

16. The robot cleaner of claim 15, wherein the window unit has a shape in which at least one surface thereof is convex toward the outside depending on the predetermined curvature.

17. The robot cleaner of claim 12, further comprising:
a power supply unit supplying power for an operation of the robot cleaner; and
a light emitting controlling unit controlling power supplied to the light emitting unit so that the strength of the emitted light is constant.

18. The robot cleaner of claim 12, wherein the window unit is exposed to the outside through the opening part of the body to be thus exposed to external light.

19. The robot cleaner of claim 18, further comprising:
a storing unit storing information for measurement of the amount of dust therein; and
an illuminance sensor sensing an illuminance of the external light, wherein the controlling unit compensates for the strength of the received light using a sensing result of the illuminance sensor and calculates the amount of dust gathered on the window unit on the basis of the compensated strength of the received light and the strength of the emitted light.

20. A dust sensor comprising:
a window unit exposed to the outside, such that dust present in the outside is gathered on the window unit;
a light emitting unit emitting light to the window unit; and
a light receiving unit receiving light reflected from the window unit, wherein the window unit has a predetermined curvature so that incident emitted light is refracted toward the outside when the emitted light is incident to a region of the window unit in which the dust is not present.

21. (canceled)
